(19) United States
(12) Patent Application Publication
(10) Pub. No.: US 2009/0223897 A1
(43) Pub. Date: Sep. 10, 2009

(54) Method for the Rejection of Boron from Seawater in a Reverse Osmosis System

(76) Inventor: Peter Villeneuve, Reno, NV (US)

Correspondence Address: Gray Robinson;ATTN: STEFAN V. STEIN/ IP DEPT., 201 N. Franklin Street, Suite 2200, Post Office Box 3324, TAMPA, FL, 33601-3324, US

(21) Appl. No.: 12/041,883

(22) Filed: Mar. 4, 2008

(51) Int. Cl. C02F 1/44; C02F 1/66

(52) U.S. Cl. 210/639

(57) ABSTRACT

Disclosed is an improved filtration system for rejecting boron from seawater. More specifically, the invention relates to a reverse osmosis (RO) system that effectively eliminates boron from seawater by increasing seawater pH prior to passage through the RO membrane. By increasing pH levels, boron removal is achieved while at the same time reducing scaling on the RO membrane.

### BACKGROUND OF THE INVENTION

1. Field of the Invention

This invention relates to an improved filtration system for the creation of drinking water. More specifically, the present invention relates to a desalination system that effectively removes boron while at the same time minimizing scaling on the filter membrane.

2. Description of the Background Art

Boron is a naturally occurring trivalent metalloid element that is found in the form of borates in the oceans, sedimentary rocks, and some soils. Trace amounts of boron can also be found naturally in air, water and in some foods. Boron exposure in humans primarily occurs through the diet and drinking-water. The World Health Organization (“WHO”) estimates that the mean global boron concentration in drinking-water is between 0.1 and 0.3 mg boron/litre.

In recent years there has been an increased awareness of the adverse health effects on humans of boron exposure. For example, exposure to large amounts of boron can lead to infections of the stomach, liver, kidneys and/or brains. In certain situations, Boron exposure can lead to death. Even exposure to smaller amounts of boron can cause nose, throat and/or eye irritations. For these reasons, the WHO now publishes guidelines for acceptable boron levels in drinking water. More specifically, the WHO recommends that all drinking water contain boron levels less than 0.5 parts per million.

Reducing boron levels is especially problematic when drinking water is created from seawater via desalination. This is because boron is found in seawater at levels of between 4 to 7 mg/l, which is 10 to 50 times the boron levels found in land water. As a result, special care must be taken to remove boron from seawater during the desalination process.

Over the years various attempts have been made to remove boron during desalination. For example, U.S. Pat. No. 7,097,769 to Liberman discloses a method of boron removal from saline in a multi-stage reverse osmosis (“RO”) process. In the second RO stage, desalination is carried out at an increased pH to yield a permeate with a lower boron concentration.

U.S. Pat. No. 5,250,185 to Tao et al. discloses a method of treating oilfield produced waters to reduce boron concentrations. Boron is removed by raising the pH above 9.5 and thereafter driving the liquid through a reverse osmosis membrane.

Finally, U.S. Pat. No. 5,925,255 to Mukhopadhyay discloses a multi-stage reverse osmosis operation. An alkali can be added prior to passing the water through an RO membrane. Increasing boron rejection by increasing pH is also disclosed.

Although the above referenced inventions achieve their individual objectives, both suffer from drawbacks. Namely, although the referenced inventions are all directed at reducing boron levels in water, none are concerned with how to achieve such boron removal without creating scale on the surface of the RO membrane.

### SUMMARY OF THE INVENTION

It is therefore one of the objectives of this invention to provide a desalination method that yields water with reduced boron levels.

It is another objective of this invention to provide a reverse osmosis system that effectively removes boron from the processed water without creating scale on the RO membrane.

It is yet another objective of this invention to provide a reverse osmosis system wherein NaOH or Ca(OH)₂ are added to increase pH to thereby more effectively remove boron.

The foregoing has outlined rather broadly the more pertinent and important features of the present invention in order that the detailed description of the invention that follows may be better understood so that the present contribution to the art can be more fully appreciated. Additional features of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a fuller understanding of the nature and objects of the invention, reference should be had to the following detailed description taken in connection with the accompanying drawings in which:

FIG. 1 is a schematic view of the primary embodiment of the present invention.

FIG. 2 is a schematic view of an additional embodiment of the present invention.

FIG. 3 is a schematic view of an additional embodiment of the present invention.

FIG. 4 is a schematic view of an additional embodiment of the present invention.

FIG. 5 is a graph of boron levels as a function of pH.

Similar reference characters refer to similar parts throughout the several views of the drawings.

### DETAILED DESCRIPTION OF THE PREFERRED EMBODIMENT

The present invention relates to an improved filtration system for rejecting boron from seawater. More specifically, the invention relates to a reverse osmosis (RO) system that effectively eliminates boron from seawater by increasing seawater pH prior to passage through the RO membrane. By increasing pH levels, boron removal is achieved while at the same time reducing scaling on the RO membrane.

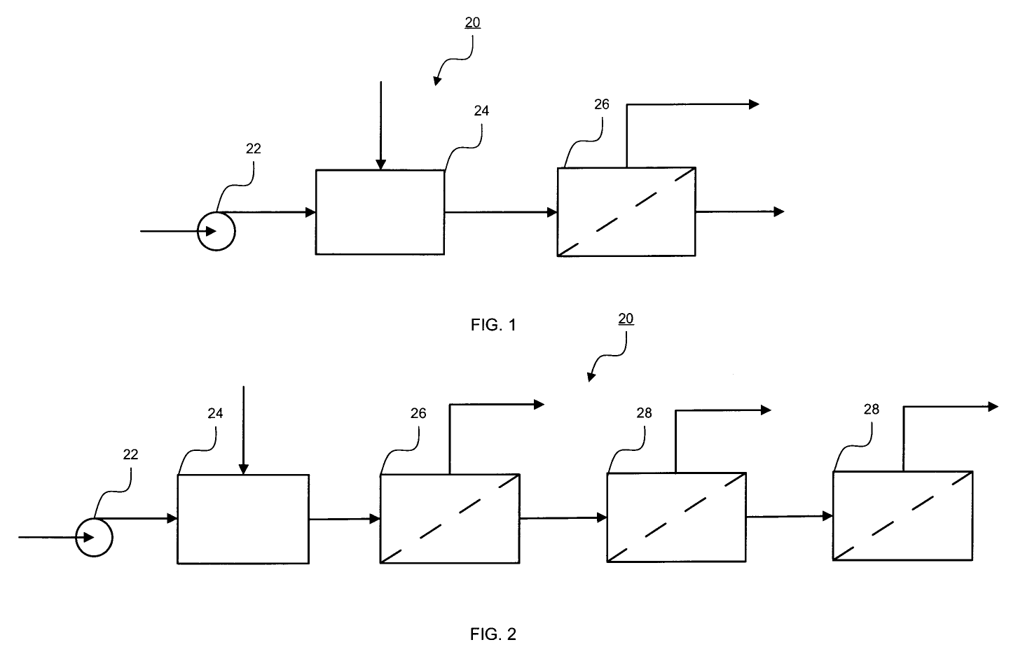

FIG. 1 is a schematic representation of the preferred embodiment of the inventive filtration system 20. FIG. 1 illustrates an initial pump 22 that is utilized for pumping seawater from a larger body, such as a reservoir or container. Pump 22 can also be employed to pump seawater directly from the ocean. Regardless of the source, the water pumped is preferably seawater having a total dissolved solids is excess of 30,000 parts per million (ppm). Brackish or fresh water is not suitable for use with the filtration system of the present invention.

With continuing reference to FIG. 1, the first step in the process is to increase the pH of the seawater and, thereby, allow for the more efficient removal of boron in subsequent steps. Increasing pH is carried out by adding sodium hydroxide (NaOH) to the pumped seawater. This can be accomplished, for example, by dissolving the sodium hydroxide within the seawater in a collection tank 24. The amount of sodium hydroxide added is preferably sufficient to elevate the pH of the pumped seawater to 9 or above. Without the additional of sodium hydroxide, seawater has a pH of between 7.5 to 8.4. Thus, the amount of sodium hydroxide added will depend, in part, on the starting pH and on the total amount of seawater being processed. Those skilled in the arts will appreciate the amount NaOH that would need to be added in order to effectively raise the pH of the seawater to 9 or above.

In the next step of the process, the seawater, with its increased pH, is passed through a conventional RO membrane 26. Those skilled in the art will be familiar with suitable RO membrane construction and its associated operation. By increasing the pH of the seawater to 9 or above prior to passage through the RO membrane a more efficient removal of boron is accomplished and boron can be effectively eliminated. Conversely, without an increased pH, boron removal is less efficient and unacceptable levels of boron are left in the resulting permeate. The output from the RO membrane is a permeate with a boron level of 0.5 ppm or less. The rejected boron, along with other unwanted contaminates, is collected in a brine reject for subsequent disposal.

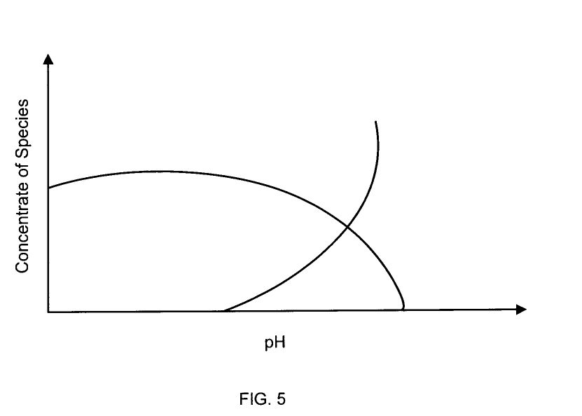

Although boron is naturally present in solid and a variety of plants, it is most prevalent in seawater. Boron exists in seawater in the form of non-ionized boric acid (B(OH)₃). Removing boron in this non-ionized form cannot be accomplished by known RO processes. However, the ionized form of boron, borate (B(OH)₄), can be removed from seawater with conventional RO techniques. Boron can be converted from its non-ionic to it ionic form by altering pH levels. FIG. 5 illustrates that as pH is increased the percentage of ionized boron is increased and the percentage of a non-ionized boron is decreased. Thus, by increasing the pH of seawater from its natural level of 7.5 to 8.4 to 9 or higher, the percentage of boron in its ionized form is maximized. With a pH of 9 or higher, conventional RO membranes can be employed to reduce boron levels to 0.5 ppm or less.

One of the discoveries associated with the present invention is that increasing seawater pH not only leads to beneficial boron rejection by the RO membrane, but it also eliminates scaling on the membrane surface. Prior attempts to increase pH prior to an RO membrane results in unacceptable accumulations of carbon deposits on membrane (“scaling”). This, in turn, reduced the throughput of the RO membrane and led to increased seawater pressure on the upstream side of the RO membrane. The result was a reduced filtration capacity and increased energy consumption by the pump. By contrast, in the present invention, because the input seawater has a total dissolved solids in excess of 30,000 parts per million (ppm), the mechanisms that lead to scaling are eliminated. More specifically, the higher amount of total dissolved solids reduces the bonding of divalents which is a known cause of scaling.

FIG. 2 is a schematic of a further embodiment of the present invention. As with the primary embodiment, this embodiment includes a pump 22 for pumping seawater, a first stage 24 for increasing pH via the addition of sodium hydroxide, and subsequent RO membrane 26 for boron removal. However, in this embodiment, the permeate from the first RO membrane is then passed through one or more additional RO membranes 28 for the removal of additional impurities and the possible further elimination of boron. By way of these subsequent stages, the purity of the resulting water can be effectively controlled.

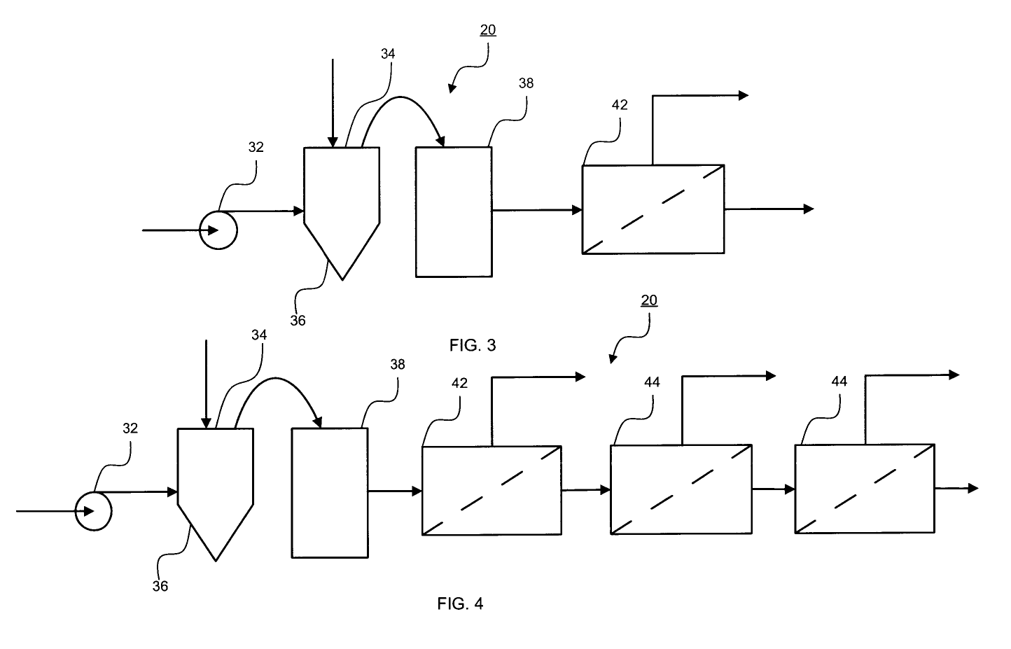

An alternative embodiment of the present invention is depicted in FIGS. 3 and 4. As with the primary embodiment, this embodiment includes a pump 32 for pumping a volume of seawater from a larger reservoir wherein the pumped seawater includes total dissolved solids in access of 30,000 ppm. Again, this embodiment increases the pH of the seawater prior to an RO membrane for the purpose of effectively eliminating boron.

However, in this alternative embodiment, the pH is increased via the addition of lime (Ca(OH) ₂). As illustrated, the pump delivers the seawater in to a filtration tank 34. A quantity of lime is then dissolved into the seawater within tank 34. A sufficient amount of lime is added to raise the pH of the seawater from its natural level of between 7.5 to 8.4 to 9 or higher. Those skilled in the art will understand how much lime needs to be added in order to achieve this elevated pH level. The use of lime to increase pH has the added benefit of precipitating out other suspended solids within seawater. The lime also functions in deactivating various microorganisms that maybe present in seawater. The use of lime to precipitate out solids and deactivate microorganisms is well known within the art. As is likewise known in the art, the bottom of the filtration tank 36 is conical and functions in collecting the suspended solids and deactivated microorganisms.

In the next step, the remaining seawater within the filtration tank is collected and passed over to a micro-filtration unit 38. A conventional micro-filtration unit with a pore size of approximately 0.1-10 micrometers is suitable for this purpose. As in known in the art, this micro-filtration unit 38 is used to remove any smaller impurities that were not participated out by the lime. Although known micro-filtration units are sufficient to successfully remove a variety of impurities, they are generally not effective in rejecting boron.

Accordingly, as noted in FIG. 3, the permeate from the micro-filtration unit is subsequently delivered to a convention RO membrane 42. Again, the objective of the RO membrane is to create a secondary permeate with a boron level of 0.5 ppm or less. The increased boron rejection is possible due to the elevated pH achieved in the filtration tank. As with the primary embodiment, due to the TDS of the seawater, the elevated pH levels do not result in scaling on the RO membrane.

FIG. 4 illustrates a further alternative embodiment. This embodiment is the same in all respects to the embodiment illustrated in FIG. 3. Here, however, additional downstream RO membranes 44 are included for achieving even more boron and/or contaminate removal. In each case, the rejected boron or other impurities are collected and discharged and the permeate is delivered for downstream processing via additional RO membranes. By way of these subsequent stages, the purity of the resulting water can be effectively controlled.

The present disclosure includes that contained in the appended claims, as well as that of the foregoing description. Although this invention has been described in its preferred form with a certain degree of particularity, it is understood that the present disclosure of the preferred form has been made only by way of example and that numerous changes in the details of construction and the combination and arrangement of parts may be resorted to without departing from the spirit and scope of the invention.

What is claimed is:

1. A filtration method for substantially removing Boron from seawater, the method comprising:
pumping a volume of seawater from a larger reservoir, wherein the total dissolved solids of the pumped seawater is in excess of 30,000 parts per million;
adding NaOH to the pumped seawater prior to any filtration, the amount of NaOH added being sufficient to elevate the pH of the pumped seawater to 9 or above;
passing the elevated pH seawater through a reverse osmosis membrane, wherein passage of the seawater through the reverse osmosis membrane does not result in any scaling;
separating a brine reject from a permeate by way of the reverse osmosis membrane, wherein Boron from the seawater is concentrated in the brine reject and reduced within the permeate to a level of approximately 0.5 parts per million or less;
passing the permeate through additional downstream reverse osmosis membranes so as to eliminate additional impurities and create potable water.

2. A filtration method for substantially removing Boron from seawater, the method comprising:
pumping a volume of seawater;
adding NaOH to the pumped seawater prior to any filtration;
passing the elevated pH seawater through a reverse osmosis membrane;
separating a brine reject from a permeate by way of the reverse osmosis membrane, wherein boron from the seawater is concentrated in the brine reject and reduced within the permeate.

3. The filtration method as described in claim 2 wherein the seawater has a total dissolved solids in excess of 30,000 parts per million.

4. The filtration method as described in claim 2 wherein the level of boron with the permeate is below 0.5 parts per million.

5. The filtration method as described in claim 2 wherein the amount of NaOH added is sufficient to elevate the pH of the pumped seawater to 9 or above passing the permeate through additional downstream reverse osmosis membranes so as to eliminate additional impurities and create potable water.

6. A filtration method for substantially removing Boron from seawater, the method comprising:
pumping a volume of seawater from a larger reservoir, wherein the total dissolved solids of the pumped seawater is in excess of 30,000 parts per million;
adding lime to the pumped seawater in a filtration tank, wherein the amount of lime added is sufficient to elevate the pH of the pumped seawater to 9 or above and wherein the lime functions to deactivate microorganisms and precipitate out suspended solids present within the seawater;
filtering the seawater with a membrane having a pore size of approximately 0.1-10 μm to thereby create a permeate with an elevated pH;
passing the permeate through a reverse osmosis membrane, wherein passage of the permeate through the reverse osmosis membrane does not result in scaling;
separating a brine reject from a secondary permeate by way of the reverse osmosis membrane, wherein Boron present in the permeate is concentrated in the brine reject and is reduced within the secondary permeate to a level of approximately 0.5 parts per million or less;
passing the secondary permeate through additional downstream reverse osmosis membranes so as to eliminate additional impurities and create potable water.

7. A filtration method for substantially removing Boron from seawater, the method comprising:
pumping a volume of seawater from a larger reservoir;
adding lime to the pumped seawater in a filtration tank, wherein the lime functions to deactivate microorganisms and precipitate out suspended solids present within the seawater;
passing the seawater through a reverse osmosis membrane, wherein boron is reduced within the permeate without scale being formed on the reverse osmosis membrane.

8. The method as described in claim 7 wherein the seawater is passed through a micro filtration unit prior to passage through the reverse osmosis membrane.

9. The method as described in claim 7 wherein the pumped seawater has a total dissolved solids in excess of 30,000 parts per million.

10. The filtration method as described in claim 7 wherein the level of boron with the permeate is below 0.5 parts per million.
